(19) United States
(12) Patent Application Publication
(10) Pub. No.: US 2011/0139407 A1
(43) Pub. Date: Jun. 16, 2011

(54) THERMOELECTRIC ENERGY STORAGE SYSTEM AND METHOD FOR STORING THERMOELECTRIC ENERGY

(75) Inventors: Christian OHLER, Baden (CH); Jaroslav Hemrle, Baden-Dattwil (CH); Mehmet Mercangoez, Baden-Dattwil (CH)

(73) Assignee: ABB Research LTD, Zurich (CH)

(21) Appl. No.: 13/029,712

(22) Filed: Feb. 17, 2011

Related U.S. Application Data
(63) Continuation of application No. PCT/EP2009/058914, filed on Jul. 13, 2009.

(30) Foreign Application Priority Data
Aug. 19, 2008 (EP) 08162614.5

(51) Int. Cl. C09K 5/10; F28D 15/00

(52) U.S. Cl. 165/104.28

(57) ABSTRACT

A system and method for thermoelectric energy storage are disclosed. A thermoelectric energy storage system can include a heat exchanger which contains a thermal storage medium, and a working fluid circuit for circulating a working fluid through the heat exchanger for heat transfer with the thermal storage medium. The working fluid undergoes transcritical cooling during the charging and transcritical heating during the discharging cycle as it exchanges heat with the thermal storage medium. Improved roundtrip efficiency can be achieved through minimizing the maximum temperature difference (ΔTmax) between the working fluid and the thermal storage medium during operating cycles.

### RELATED APPLICATIONS

This application claims priority as a continuation application under 35 U.S.C. §120 to PCT/EP2009/058914, which was filed as an International Application on Jul. 13, 2009 designating the U.S., and which claims priority to European Application 08162614.5 filed in Europe on Aug. 19, 2008. The entire contents of these applications are hereby incorporated by reference in their entireties.

### FIELD

The present disclosure relates generally to the storage of electric energy, such as systems and methods for storing electric energy in the form of thermal energy in thermal energy storage.

### BACKGROUND INFORMATION

Base load generators such as nuclear power plants and generators with stochastic, intermittent energy sources such as wind turbines and solar panels, generate excess electrical power during times of low power demand. Large-scale electrical energy storage systems can divert this excess energy to times of peak demand and balance the overall electricity generation and consumption.

In an earlier patent application EP1577548 the applicant has described a thermoelectric energy storage (TEES) system. A TEES converts excess electricity to heat in a charging cycle, stores the heat, and converts the heat back to electricity in a discharging cycle, when desired. Such an energy storage system is robust, compact, site independent and is suited to the storage of electrical energy in large amounts. Thermal energy can be stored in the form of sensible heat via a change in temperature or in the form of latent heat via a change of phase or a combination of both. The storage medium for the sensible heat can be a solid, liquid, or a gas. The storage medium for the latent heat occurs via a change of phase and can involve any of these phases or a combination of them in series or in parallel.

The round-trip efficiency of an electrical energy storage system can be defined as the percentage of electrical energy that can be discharged from the storage in comparison to the electrical energy used to charge the storage, provided that the state of the energy storage system after discharging returns to its initial condition before charging of the storage. All electric energy storage technologies inherently have a limited round-trip efficiency. Thus, for every unit of electrical energy used to charge the storage, only a certain percentage is recovered as electrical energy upon discharge. The rest of the electrical energy is lost. If, for example, the heat being stored in a TEES system is provided through resistor heaters, it has approximately 40% round-trip efficiency. The efficiency of thermoelectric energy storage is limited for various reasons rooted in the second law of thermodynamics. Firstly, the conversion of heat to mechanical work in a heat engine is limited to the Carnot efficiency. Secondly, the coefficient of performance of any heat pump declines with increased difference between input and output temperature levels. Thirdly, any heat flow from a working fluid to a thermal storage and vice versa involves a temperature difference in order to happen. This fact inevitably degrades the temperature level and thus the capability of the heat to do work.

It is noted that many industrial processes involve provision of thermal energy and storage of the thermal energy. Examples are refrigeration devices, heat pumps, air conditioning and the process industry. In solar thermal power plants, heat is provided, possibly stored, and converted to electrical energy. However, all these applications are distinct from TEES systems because they are not concerned with heat for the exclusive purpose of storing electricity.

It is also noted that the charging cycle of a TEES system is also referred to as a heat pump cycle and the discharging cycle of a TEES system is also referred to as a heat engine cycle. In the TEES concept, heat needs to be transferred from a hot working fluid to a thermal storage medium during the heat pump cycle and back from the thermal storage medium to the working fluid during the heat engine cycle. A heat pump requires work to move thermal energy from a cold source to a warmer heat sink. Since the amount of energy deposited at the hot side is greater than the work required by an amount equal to the energy taken from the cold side, a heat pump will “multiply” the heat as compared to resistive heat generation. The ratio of heat output to work input is called coefficient of performance, and it is a value larger than one. In this way, the use of a heat pump will increase the round-trip efficiency of a TEES system.

The thermodynamic cycles selected for charging and discharging of the TEES affect many practical aspects of the storage. For example, the amount of thermal energy storage required to store a given amount of electrical energy during charging of the TEES depends on the temperature level of the thermal storage, when the ambient is used as a heat sink for the discharging. The higher the thermal storage temperature with respect to the ambient, the lower will be the relative proportion of the stored thermal energy not recoverable as electrical work. Therefore, when a charging cycle with a relatively low top temperature is employed, a larger amount of heat need to be stored to store the same amount of electrical energy as compared to a charging cycle with a relatively higher top temperature.

FIG. 1 illustrates temperature profiles of a known TEES system. The abscissa represents enthalpy changes in the system, the ordinate represents the temperature, and the lines on the graph are isobars. The solid line indicates the temperature profile of the working fluid in a known TEES charging cycle, and the stepped stages of desuperheating 10, condensing 12 and subcooling 14 are shown (from right to left). The dotted line indicates the temperature profile of the working fluid in a known TEES discharging cycle, and the stepped stages of preheating 16, boiling 18 and superheating 20 are shown (from left to right). The straight diagonal dashed line indicates the temperature profile of the thermal storage medium in a known TEES cycle. Heat can only flow from a higher to a lower temperature. Consequently, the characteristic profile for the working fluid during cooling in the charging cycle has to be above the characteristic profile for the thermal storage media, which in turn has to be above the characteristic profile for the working fluid during heating in the discharging cycle.

It is established that a thermodynamic irreversibility factor is the transfer of heat over large temperature differences. In FIG. 1, it can be observed that during the condensing part 12 of the charging profile and during the boiling part 18 of the discharging profile, the working fluid temperature stays constant. This leads to a relatively large maximum temperature difference, indicated as ΔTmax, between the thermal storage medium and the working fluid (whether charging or discharging), thereby reducing the roundtrip efficiency. In order to minimize this maximum temperature difference, relatively large heat exchangers could be constructed or phase change materials can be used for thermal storage. These solutions can result in a high capital cost and therefore are not generally practical.

Exemplary embodiments as disclosed herein are directed to providing an efficient thermoelectric energy storage having a high round-trip efficiency, whilst minimising the heat exchangers' area and the amount of required thermal storage medium, and also minimizing capital cost.

### SUMMARY

A thermoelectric energy storage system is disclosed for providing thermal energy to a thermodynamic machine for generating electricity, comprising: a heat exchanger which contains a thermal storage medium; and a working fluid circuit for circulating a working fluid through the heat exchanger for heat transfer with the thermal storage medium, such that the working fluid will undergo a transcritical process during heat transfer.

A method for storing thermoelectric energy in a thermoelectric energy storage system is disclosed, comprising: circulating a working fluid through a heat exchanger for heat transfer with a thermal storage medium; and transferring heat with the thermal storage medium in a transcritical process.

### BRIEF DESCRIPTION OF THE DRAWINGS

The subject matter of the disclosure will be explained in more detail in the following text with reference to exemplary embodiments, which are illustrated in the attached drawings, in which:

FIG. 1 shows an exemplary heat energy-temperature diagram of heat transfer from cycles in a known TEES system;

FIG. 2 shows an exemplary simplified schematic diagram of a charging cycle of a thermoelectric energy storage system as disclosed herein;

FIG. 3 shows an exemplary simplified schematic diagram of a discharging cycle of a thermoelectric energy storage system as disclosed herein;

FIG. 4 shows an exemplary heat energy-temperature diagram of heat transfer from cycles in a TEES system as disclosed in the present disclosure;

FIG. 5a is an exemplary enthalpy-pressure diagram of cycles in a TEES system as disclosed in the present disclosure; and

FIG. 5b is an exemplary entropy-temperature diagram of cycles in a TEES system as disclosed in the present disclosure.

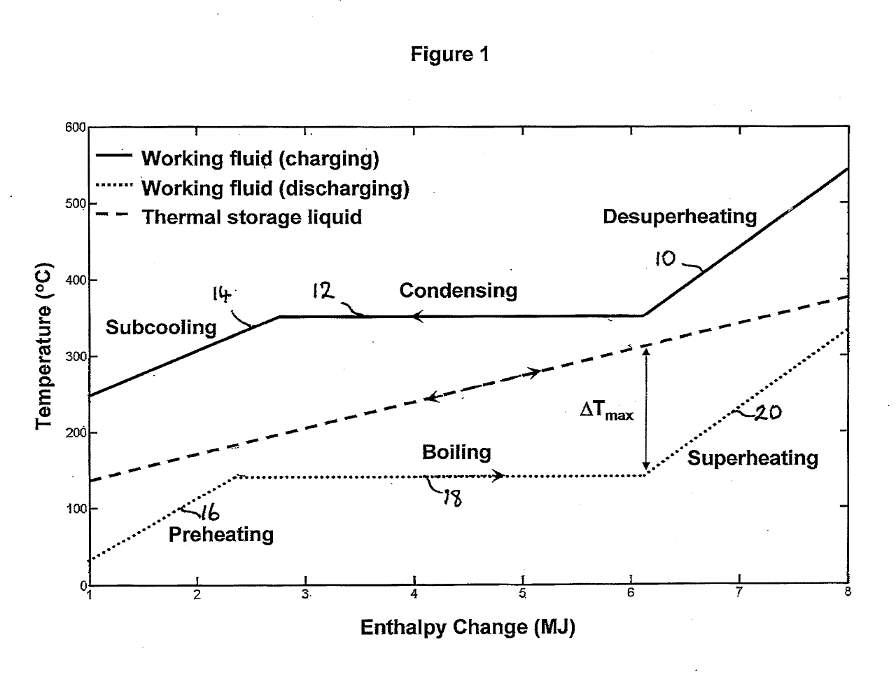

For consistency, the same reference numerals are used to denote similar elements illustrated throughout the figures.

### DETAILED DESCRIPTION

A thermoelectric energy storage system is disclosed herein for converting electrical energy into thermal energy to be stored and converted back to electrical energy with an improved round-trip efficiency.

According to a first exemplary aspect of the disclosure, a thermoelectric energy storage system is provided which comprises a heat exchanger which contains a thermal storage medium, a working fluid circuit for circulating a working fluid through the heat exchanger for heat transfer with the thermal storage medium, and wherein the working fluid undergoes a transcritical process during heat transfer.

In an exemplary embodiment the thermal storage medium is a liquid. In a further exemplary embodiment the thermal storage medium is water.

The working fluid undergoes a transcritical cooling in the heat exchanger during a charging cycle of the thermoelectric energy storage system. When the thermoelectric energy storage system is in a charging (or “heat pump”) cycle, the system includes an expander, an evaporator and a compressor.

The working fluid undergoes a transcritical heating in the heat exchanger during a discharging cycle of the thermoelectric energy storage system. When the thermoelectric energy storage system is in a discharging (or “heat engine”) cycle, the system includes a pump, a condenser and a turbine.

In an exemplary embodiment, the working fluid is in a supercritical state on entering the heat exchanger during a charging cycle of the thermoelectric energy storage system. Further, the working fluid is in a supercritical state on exiting the heat exchanger during a discharging cycle of the thermoelectric energy storage system.

In a further exemplary embodiment, a system as disclosed herein can comprise an expander positioned in the working fluid circuit for recovering energy from the working fluid during the charging cycle, wherein the recovered energy is supplied to a compressor in the working fluid circuit for compressing the working fluid to a supercritical state.

The TEES system based on transcritical cycles can work without a cold storage (i.e. by exchanging heat with the ambient instead of a cold thermal storage) and without phase change materials, whilst providing a reasonable back-work ratio for high roundtrip efficiency.

In a second exemplary; aspect of the present disclosure, a method is provided for storing thermoelectric energy in a thermoelectric energy storage system, the method comprising circulating a working fluid through a heat exchanger for heat transfer with a thermal storage medium, and transferring heat with the thermal storage medium in a transcritical process.

For example, the transferring of heat can comprise transcritical cooling of the working fluid during a charging cycle of the thermoelectric energy storage system.

Further the transferring of heat can comprise transcritical heating of the working fluid during a discharging cycle of the thermoelectric energy storage system.

For example, the method of the present disclosure can comprise modifying the thermoelectric energy storage system parameters to ensure the maximum temperature difference between the working fluid and the thermal storage medium is minimized during charging and discharging.

To ensure that the maximum temperature difference between the working fluid and the thermal storage medium is minimized during charging and discharging cycles, the following exemplary system parameters may be modified; operating temperature and pressure levels, the type of working fluid used, the type of thermal storage medium used, heat exchanger area.

An aim of the heat pump-heat engine based TEES system and method of operation can be to achieve as close as possible reversible operation of the thermodynamic cycles. Since the cycles are coupled through the heat storage mechanism and therefore through the temperature-enthalpy diagrams, approximating the working fluid profiles by the heat storage medium profile can be important to achieve reversible operation.

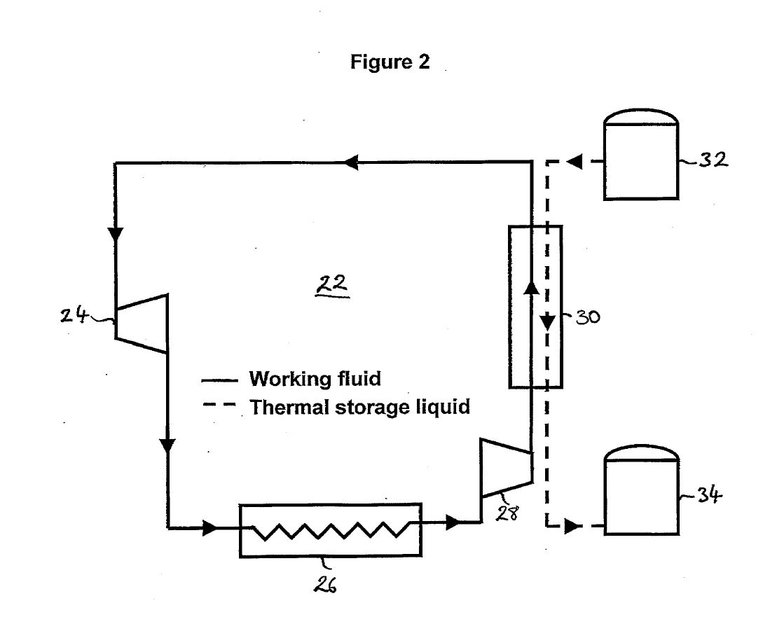

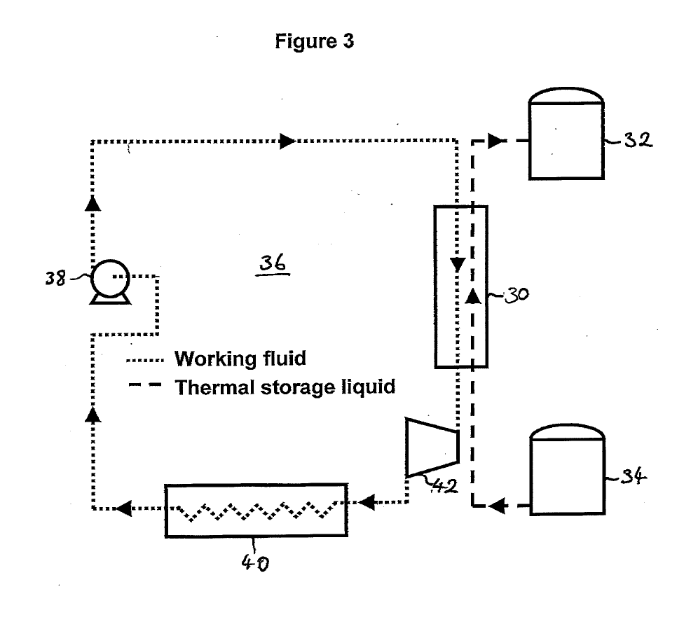

FIGS. 2 and 3 schematically depict a charging cycle system and a discharging cycle system, respectively, of an exemplary TEES system in accordance with an embodiment of the present disclosure.

The charging cycle system 22 shown in FIG. 2 can comprise a work recovering expander 24, an evaporator 26, a compressor 28 and a heat exchanger 30. A working fluid circulates through these components as indicated by the solid line with arrows in FIG. 2. Further, a cold-fluid storage tank 32 and a hot-fluid storage tank 34 containing a fluid thermal storage medium are coupled together via the heat exchanger.

In operation, the charging cycle system 22 performs a transcritical cycle and the working fluid flows around the TEES system in the following manner. The working fluid in the evaporator 26 absorbs heat from the ambient or from a cold storage and evaporates. The vaporized working fluid is circulated to the compressor 28 and surplus electrical energy is utilized to compress and heat the working fluid to a supercritical state. (In such a supercritical state, the fluid is above the critical temperature and critical pressure.) This constitutes a pivotal feature of the transcritical cycle. The working fluid is fed through the heat exchanger 30 where the working fluid discards heat energy into the thermal storage medium.

It is noted that in the heat exchanger the working fluid pressure will be above the critical pressure, however the working fluid temperature may go below the critical temperature. Therefore, whilst the working fluid enters the heat exchanger in a supercritical state, it may leave the heat exchanger 30 in a subcritical state.

The compressed working fluid exits the heat exchanger 30 and enters the expander 24. Here the working fluid is expanded to the lower pressure of the evaporator. The working fluid flows from the expander 24 back into the evaporator 26.

The thermal storage medium, represented by the dashed line in FIG. 2, is pumped from the cold-fluid storage tank 32 through the heat exchanger 30 to the hot-fluid storage tank 34. The heat energy discarded from the working fluid into the thermal storage medium is stored in the form of sensible heat.

A transcritical cycle is defined as a thermodynamic cycle where the working fluid goes through both subcritical and supercritical states. There is no distinction between a gas phase and a vapor phase beyond the supercritical pressure and therefore there is no evaporation or boiling (in the regular meaning) in the transcritical cycle.

The discharging cycle system 36 shown in FIG. 3 comprises a pump 38, a condenser 40, a turbine 42 and a heat exchanger 30. A working fluid circulates through these components as indicated by the dotted line with arrows in FIG. 3. Further, a cold storage tank 32 and a hot storage tank 34 containing a fluid thermal storage medium are coupled together via the heat exchanger 30 . The thermal storage medium, represented by the dashed line in FIG. 3, is pumped from the hot-fluid storage tank 34 through the heat exchanger 30 to the cold-fluid storage tank 32.

In operation, the discharging cycle system 36 also performs a transcritical cycle and the working fluid flows around the TEES system in the following manner. Heat energy is transferred from the thermal storage medium to the working fluid causing the working fluid to go through transcritical heating. The working fluid then exits the heat exchanger 30 in a supercritical state and enters the turbine 42 where the working fluid is expanded thereby causing the turbine to generate electrical energy. Next, the working fluid enters the condenser 40, where the working fluid is condensed by exchanging heat energy with the ambient or a cold storage. The condensed working fluid exits the condenser 40 via an outlet and is pumped again beyond its critical pressure into the heat exchanger 40 via the pump 38.

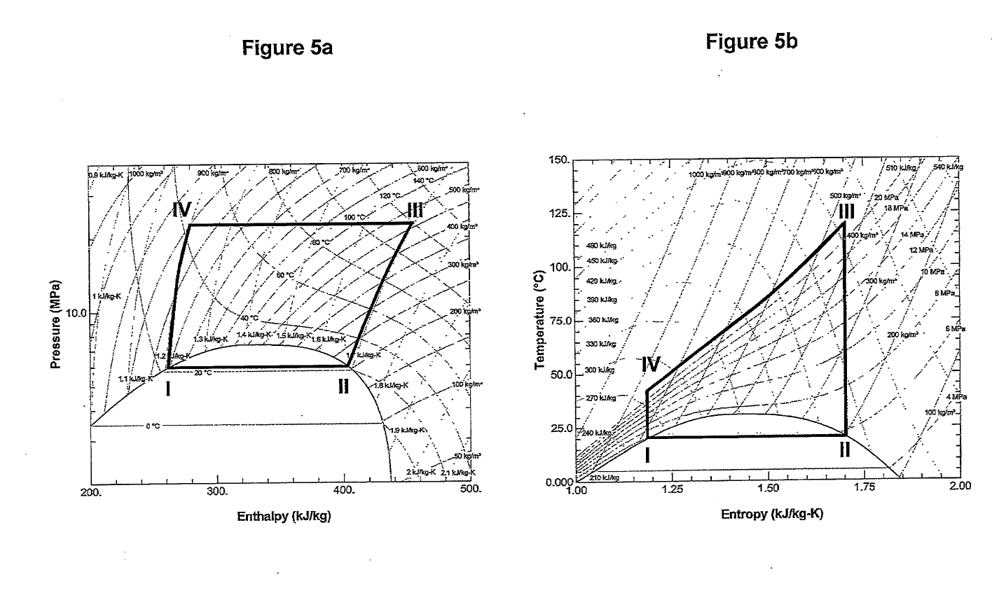

While the charging cycle system 22 of FIG. 2 and the discharging cycle system 36 of FIG. 3 have been illustrated separately, the heat exchanger 30, cold-fluid storage 32, hot-fluid storage 34 and thermal storage medium is common to both. The charging and discharging cycles may be performed consecutively, not simultaneously. These two complete cycles are clearly shown in an enthalpy-pressure diagram, such as FIG. 5a.

In an exemplary embodiment, the heat exchanger 30 is a counterflow heat exchanger, and the working fluid of the cycle is, for example, carbon dioxide. Further, the thermal storage medium is a fluid, and is, for example, water. The compressor 28 of the present embodiment is an electrically powered compressor.

In an exemplary embodiment of the present disclosure, the counterflow heat exchanger 30 may have a minimal approach temperature, ΔTmin, of 5 K (ie. the minimal temperature difference between the two fluids exchanging heat is 5 K). The approach temperature should be as low as possible.

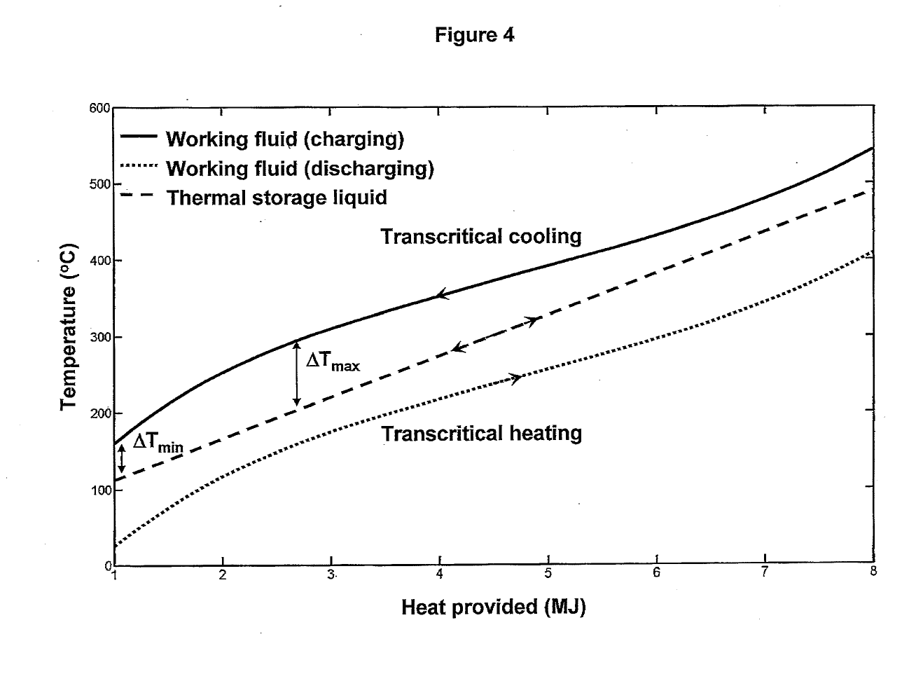

FIG. 4 shows an exemplary heat energy-temperature diagram of the heat transfer in the heat exchanger during the cycles in a TEES system in accordance with the present disclosure. The solid line indicates the temperature profile of the working fluid in the TEES charging cycle. The dotted line indicates the temperature profile of the working fluid in the TEES discharging cycle. The dashed line indicates the temperature profile of the thermal storage medium in the TEES cycle. Heat can only flow from a higher to a lower temperature. Consequently, the characteristic profile for the working fluid during cooling in the charging cycle has to be above the characteristic profile for the thermal storage media, which in turn has to be above the characteristic profile for the working fluid during heating in the discharging cycle.

The temperature profiles are stationary in time due to the sensible heat storage in the thermal storage medium. Thus, whilst the volume of thermal storage medium in the heat exchanger remains constant, the volume of hot and cold thermal storage medium stored in the hot-fluid and cold-fluid storage tanks changes. Also, the temperature distribution in the heat exchanger remains constant.

In FIG. 4, it can be observed that during the charging cycle of the TEES system, a smooth transcritical cooling occurs and no condensation stage is experienced as the working fluid cools down. Similarly, during the discharging cycle of the TEES system, a smooth transcritical heating occurs and no boiling stage is experienced as the working fluid heats up. This results in a relatively reduced maximum temperature difference, ΔTmax, between the thermal storage medium and the working fluid (whether charging or discharging), thereby increasing the roundtrip efficiency and more closely approaching reversible operation.

The solid-line quadrangle shown in the enthalpy-pressure diagram of FIG. 5a represents both the charging and discharging cycles of the TEES system of the present disclosure. For example, the charging cycle follows a counter-clockwise direction and the discharging cycle follows a clockwise direction. The transcritical charging cycle is now described. The working fluid is assumed to be carbon dioxide for this exemplary embodiment.

The cycle commences at point I which corresponds to the working fluid state prior to receiving heat from the evaporator. At this point the working fluid has a relatively low pressure and the temperature may be between 0° C. and 20° C. Evaporation occurs at point II at constant pressure and temperature, and then the working fluid vapour is compressed isentropically in a compressor into the state III. In state III the working fluid is supercritical and may be at a temperature of approximately between 90° C. to 150° C. and the working fluid pressure may be up to the order of 20 MPa. However, this is dependent upon the combination of the working fluid and the thermal storage medium utilized, as well as on the reached temperature. As the working fluid passes through the heat exchanger, the heat energy from the working fluid is transferred in isobaric process to the thermal storage medium, thereby cooling the working fluid. This is represented in FIG. 5a as the section from point III to point IV. Energy is recovered as the working fluid then passes through the expander and expands from point IV to point I. The recovered energy may be used to co-power the compressor, either by mechanical or electrical link. In this manner, the working fluid attains its original low pressure state.

The transcritical discharging cycle follows the same path shown in FIG. 5a, but in a clockwise direction as each of the processes are reversed. It should be noted that the compression stage between point I and point IV is, for example, an isentropic compression.

In an alternative exemplary embodiment, the stage of the charging cycle from point IV to point I in which the working fluid expands, may utilize an adiabatic expansion valve. In this embodiment, energy is lost due to the irreversibility of such an adiabatic isenthalpic expansion process.

The solid-line quadrangle shown in the entropy-temperature diagram of FIG. 5b represents both the charging and discharging cycles of the TEES system of the present disclosure. For example, the transcritical charging cycle follows a counter-clockwise direction and the transcritical discharging cycle follows a clockwise direction. The working fluid is assumed to be carbon dioxide for this exemplary embodiment. In this diagram the constant temperature with increasing entropy between point I and point II can clearly be seen and also the constant entropy with increasing temperature between point II and point III can be seen. In the exemplary embodiment shown in FIG. 5b, the entropy of the working fluid falls from 1.70 KJ/kg-K to 1.20 KJ/kg-K during the smooth transcritical cooling between point III, at 120° C., and point IV, at 42° C., in the charging cycle. The transition from point IV to point I occurs with a drop in temperature and the entropy of the working fluid remains constant.

The skilled person will be aware that the TEES system, as illustrated in FIGS. 2 and 3, may be realized in several different ways. Exemplary alternative embodiments include:

Different working fluids may be utilized for the charging and discharging cycles in order to maximize the roundtrip efficiency. Examples of working fluids that may be used are any refrigerant with a critical temperature between the low and high temperature levels of the cycles.

Different heat exchangers may be utilized for the charging and discharging cycles in order to optimize the process and dependent upon the exemplary arrangement for operation.

Instead of the ambient, a dedicated cold storage can be used as a heat source for the charging cycle and a heat sink for discharging cycle. The cold storage can be realized by producing ice-water mixture during charging of the storage, and using the stored ice-water mixture to condense the working fluid during the discharge cycle. In the conditions when the temperature of the cold storage can be increased for charging (e.g. using solar ponds or added heating by locally available waste heat) or reduced for discharging, this can be used to increase the round-trip efficiency.

Due to the proximity of the cycles to a critical point of the working fluid, the expansion work recovery in the expansion valve can be a significant fraction of the compression work under the conditions near the critical point. Therefore, the expansion work recovery may be incorporated into the design of the TEES system.

While the thermal storage medium is, for example, water (if desired, in a pressurized container), other materials, such as oil or molten salt, may also be used. Water has relatively good heat transfer and transport properties and a high heat capacity, and therefore a relatively small volume can be used for a predetermined heat storage capability. Clearly, water is non-flammable, non-toxic and environmentally friendly. Choice of a cheap thermal storage medium would contribute to a lower overall system cost.

The skilled person in the art will recognize that the condenser and the evaporator in the TEES system may be replaced with a multi-purpose heat exchange device that can assume both roles, since the use of the evaporator (26) in the charging cycle and the use of the condensator (40) in the discharging cycle will be carried out in different periods. Similarly the turbine (42) and the compressor (28) roles can be carried out by the same machinery, referred to herein as a thermodynamic machine, capable of achieving both tasks.

An exemplary working fluid for the instant disclosure is carbon dioxide; mainly due to the higher efficiencies in heat transfer processes and the amiable properties of carbon dioxide as a natural working fluid (e.g., non-flammable, no ozone depletion potential, no health hazards and so forth).

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A thermoelectric energy storage system for providing thermal energy to a thermodynamic machine for generating electricity, comprising:
a heat exchanger which contains a thermal storage medium; and
a working fluid circuit for circulating a working fluid through the heat exchanger for heat transfer with the thermal storage medium, such that the working fluid will undergo a transcritical process during heat transfer.

2. The system according to claim 1, wherein the working fluid is selected to undergo a transcritical cooling in the heat exchanger during a charging cycle of the thermoelectric energy storage system.

3. The system according to claim 1, wherein the working fluid is selected to undergo a transcritical heating in the heat exchanger during a discharging cycle of the thermoelectric energy storage system.

4. The system according to claim 1, wherein the working fluid is selected to be in a supercritical state on entering the heat exchanger during a charging cycle of the thermoelectric energy storage system.

5. The system according to claim 1, wherein the working fluid is selected to be in a supercritical state on exiting the heat exchanger during a discharging cycle of the thermoelectric energy storage system.

6. The system according to claim 1, comprising:
an expander positioned in the working fluid circuit for recovering energy from the working fluid during a charging cycle, wherein recovered energy is supplied to a compressor in the working fluid circuit for compressing the working fluid to a supercritical state.

7. A method for storing thermoelectric energy in a thermoelectric energy storage system, comprising;
circulating a working fluid through a heat exchanger for heat transfer with a thermal storage medium; and
transferring heat with the thermal storage medium in a transcritical process.

8. The method according to claim 7, wherein the transferring of heat comprises:
transcritical cooling of the working fluid during a charging cycle of the thermoelectric energy storage system.

9. The method according to claim 7, wherein the transferring of heat comprises:
transcritical heating of the working fluid during a discharging cycle of the thermoelectric energy storage system.

10. The method according to claim 7, comprising:
modifying the thermoelectric energy storage system parameters such that a maximum temperature difference between the working fluid and the thermal storage medium is minimized during charging and discharging.

11. The system according to claim 2, wherein the working fluid is selected to undergo a transcritical heating in the heat exchanger during a discharging cycle of the thermoelectric energy storage system.

12. The system according to claim 11, wherein the working fluid is selected to be in a supercritical state on entering the heat exchanger during a charging cycle of the thermoelectric energy storage system.

13. The system according to claim 12, wherein the working fluid is selected to be in a supercritical state on exiting the heat exchanger during a discharging cycle of the thermoelectric energy storage system.

14. The system according to claim 2, comprising;
an expander positioned in the working fluid circuit for recovering energy from the working fluid during a charging cycle, wherein recovered energy is supplied to a compressor in the working fluid circuit for compressing the working fluid to a supercritical state.

15. The method according to claim 8, wherein the transferring of heat comprises:
transcritical heating of the working fluid during a discharging cycle of the thermoelectric energy storage system.

16. The method according to claim 15, comprising:
modifying the thermoelectric energy storage system parameters such that a maximum temperature difference between the working fluid and the thermal storage medium is minimized during charging and discharging.
